(19) United States
(12) Patent Application Publication
(10) Pub. No.: US 2016/0269496 A1
(43) Pub. Date: Sep. 15, 2016

(54) METHOD AND APPLICATION SERVER FOR EXECUTING A SERVICE-RELATED OPERATION FOR A DEVICE USER

(71) Applicant: TELEFONAKTIEBOLAGET L M ERICSSON (PUBL), Stockholm (SE)

(72) Inventors: Jan LIDIN, Huddinge (SE); Ester GONZALEZ DE LANGARICA, Stockholm (SE); Mats STILLE, Bromma (SE)

(73) Assignee: TELEFONAKTIEBOLAGET L M ERICSSON (PUBL), Stockholm (SE)

(21) Appl. No.: 15/031,475

(22) PCT Filed: Oct. 25, 2013
(86) PCT No.: PCT/SE2013/051249

§ 371 Date: Apr. 22, 2016

(51) Int. Cl. H04L 29/08; H04W 4/02; H04L 29/06

(52) U.S. Cl. CPC H04L 67/18; H04L 65/1063; H04W 4/023; H04L 65/1016

(57) ABSTRACT

A method and an application server for executing a service-related operation for a device user in communication with an opposite communication entity, wherein the device user has a subscription that is valid for a set of devices. The application server obtains a location of a primary device assigned to indicate the device user's location, and also a location of each of at least one secondary device of the set of devices. The service-related operation is then executed with restriction to the primary device and to those of the secondary devices, if any, that are located within a predetermined proximity range to the primary device, i.e. presumably within reach for the user. Unnecessary signaling and alerting can thereby be avoided since the service-related operation will not be executed for any secondary device that is beyond reach for the user and thus cannot be used for communication.

### TECHNICAL FIELD

The present disclosure relates generally to a method and an application server of a communication network, for executing a service-related operation for a device user in communication with an opposite communication entity.

### BACKGROUND

In the field of telecommunication, it is quite common nowadays that a device user owns multiple communication devices of different kinds and that the device user has a subscription with a network operator that is valid for all his/her devices. For example, a device user may have a mobile phone, or “smartphone”, that can be easily carried along wherever the user goes, and a tablet which may or may not be brought along as well. The device user may further have a Personal Computer, PC, which is installed at home and which is therefore stationary and not moved around, just to mention some typical examples. In this disclosure, the term “device” will be used for short to represent any communication terminal or device capable of carrying out a communication session with an opposite party or communication entity such as another device or a server or other service node. The communication session may involve, e.g. a voice call, a video call or conference, an e-mail, a file transfer, a chat session, and so forth.

In communication networks of today, it is of great interest to achieve a network and/or service performance that is good enough, e.g. in terms of capacity quality and efficiency, to satisfy the demands from subscribers. Since the traffic load is steadily increasing in the networks, mainly due to increased user activities and the introduction of ever more advanced devices and services, network operators are constantly striving to improve the efficiency of the network. For example, it is of great interest to keep the amount of signaling as low as possible to give room for more communication of data, or “payload”, particularly in a network for wireless communication over an air interface with limited radio resources.

When a user has multiple devices and an opposite communication entity issues a request for communication or capability exchange towards the user, it is common that the request is forwarded to all the devices, which is a mechanism referred to as “forking”. Prior to establishing the actual communication, it is customary to exchange device capabilities to explore which services are available and possible to be used by both parties. In other words, it must be established that the devices of both parties are capable of a particular service before it can be executed, which is a process called service discovery.

For example, in the field of IP Multimedia Subsystem, IMS, and when using the Session Initiation Protocol, SIP, a device of a user “A” may query a user “B” for device capabilities by sending a capability request in the form of a “SIPOPTIONS” message. This message is received and processed by an application server in user B's IMS network and it is determined which devices are valid for user Bs subscription. Then, a Serving Call and Session Control Function, S-CSCF, of user B forks the request to all devices of B which then respond by sending their respective capabilities towards the device of user A, typically via an application server that aggregates the capabilities for user A. The same procedure of forking is applied also for communication requests.

FIG. 1 illustrates a communication scenario where a device of user A issues a request, as of action 1:1, which is directed to a user B having multiple devices, including a mobile phone B1, a tablet B2, a PC B3 and possibly further devices, not shown. The request may be a communication request or a capability request, which is received by an S-CSCF node 100 in user B's IMS network and forwarded to an application server 102, as of action 1:2. The application server 102 then instructs the S-CSCF node 100, as of action 1:3, to fork the request to the devices B1, B2, B3 . . . and the S-CSCF node 100 accordingly sends a copy of the request to B's all devices B1, B2, B3 . . . , as of action 1:4. When the devices B1, B2, B3 . . . return their respective capabilities, not shown, the S-CSCF node 100 sends an aggregated response to device A, as shown by action 1:5, such that the services available in communication with any of B's devices can be displayed to user A on the device A. The user A then naturally believes that all the displayed services can be used in a communication with user B.

A similar forking operation would be performed for a communication request from user A which results in that all the devices of user B capable of supporting the communication will be alerted, e.g. ring, simultaneously. Once the user activates one of the devices, the network makes all the other alerted devices to become silent.

However, some of the devices B1, B2, B3 . . . may not be within reach of the user B and will thus ring or otherwise be alerted in vain, which involves a certain amount of signaling though the communication network to no avail, thus wasting resources in the network. This would also be the case for capability exchange which will be useless for those devices beyond reach of user B which likewise cannot be used in a forthcoming communication. For example, the user may currently be away from home carrying his mobile phone B1 while the tablet B2 and the PC B3 have been left at home. The user will therefore only be able to communicate with the mobile phone B1 but not with the other devices B2, B3 . . . .

There is currently a possibility available for the user to manually de-activate one or more of his devices such that they will not ring nor exchange capabilities upon an incoming communication request, but this requires that the user remembers to de-activate and re-activate the devices depending on the situation, which may be perceived as bothersome and inconvenient. Moreover, any changes in capability of a device will not become updated in the network during periods when the device is de-activated.

To conclude, there are at least two problems associated with the above-described conventional mechanism of forking for service-related operations. Firstly, valuable network resources are wasted due to useless signaling to and from devices that will not be used anyway. Secondly, the opposite user will be misled by being presented services available in devices that are beyond reach of the user B which will thus not be possible to use anyway in a forthcoming communication.

### SUMMARY

It is an object of embodiments described herein to address at least some of the problems and issues outlined above. It is possible to achieve this object and others by using a method and an application server as defined in the attached independent claims.

According to one aspect, a method is performed by an application server associated with a communication network, for executing a service-related operation for a device user in communication with an opposite communication entity. It is assumed that the device user has a subscription that is valid for a set of devices. In this method, the application server obtains a location of a primary device of the set of devices, wherein the primary device has been assigned to indicate the device user's location. The application server also obtains a location of each of at least one secondary device of the set of devices and executes the service-related operation with restriction to the primary device and to any of the at least one secondary device being located within a predetermined proximity range to the primary device. Thereby, unnecessary signaling with the user's devices may be avoided by excluding any devices being beyond reach of the user from the signaling.

According to another aspect, an application server associated with a communication network is arranged to execute a service-related operation for a device user in communication with an opposite communication entity, wherein the device user has a subscription that is valid for a set of devices. The application server comprises a locating unit that is adapted to obtain a location of a primary device of the set of devices, wherein the primary device has been assigned to indicate the device user's location. The locating unit is also adapted to obtain a location of each of the at least one secondary device.

The application server further comprises a logic unit that is adapted to determine whether at least one secondary device of the set of devices is located within a predetermined proximity range to the primary device. The application server also comprises an executing unit adapted to execute the service-related operation with restriction to the primary device and to any of the at least one secondary device being located within the predetermined proximity range to the primary device.

According to another aspect, a computer program comprises computer readable code which, when run on an application server, causes the application server to perform a method according to any of the embodiments described herein. In a further aspect, an apparatus is adapted to perform a method according to any of the embodiments described herein.

The above method and application server may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1 is a communication scenario illustrating a forking operation to multiple devices, according to the prior art.

FIG. 2 is a flow chart illustrating a procedure in an application server, according to further possible embodiments.

FIG. 3 is a communication scenario illustrating a forking operation when the solution is used, according to some possible embodiments.

FIG. 4 is a more detailed example of a flow chart illustrating a procedure in an application server, according to further possible embodiments.

FIG. 5 is a flow chart illustrating another example of a procedure in an application server, according to further possible embodiments.

FIG. 6 is a flow chart illustrating yet another example of a procedure in an application server, according to further possible embodiments.

FIG. 7 is a block diagram illustrating an application server in more detail, according to further possible embodiments.

FIG. 8 is a signaling diagram illustrating an example of a procedure for registration when the solution is used in practice, according to further possible embodiments.

FIGS. 9-12 are signaling diagrams illustrating further examples of how the solution may be used in practice for capability exchange and communication, according to further possible embodiments.

### DETAILED DESCRIPTION

Briefly described, a solution is provided to avoid the above-described unnecessary signaling with multiple devices of user B, by exchanging device capabilities, or forking a communication request, only with or to those devices that are within reach of user B while his/her other devices being beyond reach will be excluded from the signaling involved. This can be achieved by functionality in an application server that is associated with a communication network where a device user has a subscription that is valid for a set of devices, which may include a mobile phone, a tablet, a PC, to mention some customary examples. The solution is however not limited to being useful for any particular number or types of devices and it is assumed that the user has at least two devices that have been registered for the subscription. The communication network may comprise an IMS core and the user may be an IMS subscriber, although the solution is not limited to IMS.

In the following disclosure, the term “service-related operation” will be used to represent any operation that involves signaling with a user's device. Two main examples of a service-related operation will be discussed here, namely exchanging device capabilities and sending a communication request, although the embodiments described herein may be applied for other service-related operations as well requiring some responsive action at the device.

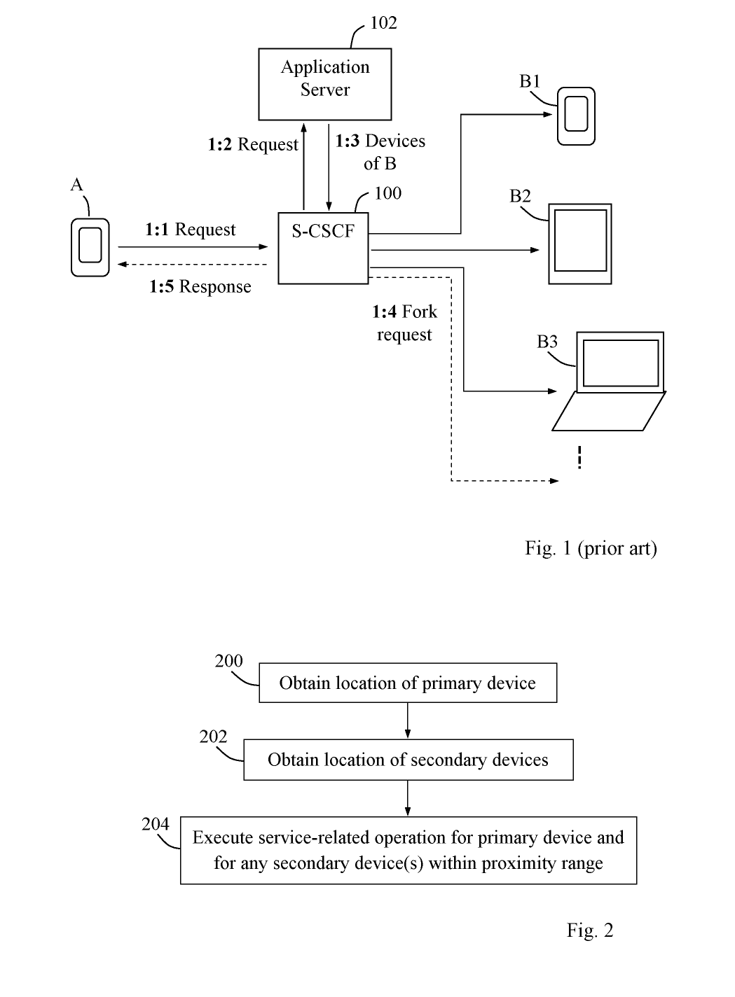

The solution and some possible embodiments will now be outlined with reference to the flow chart of FIG. 2 which illustrates actions performed by an application server associated with a communication network. These actions can thus be executed by the application server for executing a service-related operation for a device user “B” in communication with an opposite communication entity “A”, wherein the device user B has a subscription that is valid for a set of devices. A first action 200 illustrates that the application server obtains a location of a primary device of the set of devices, wherein the primary device has been assigned to indicate the device user's location.

It is therefore required that one of user B's devices has been appointed or identified to be the primary device in this context which is appropriately the device that the user is most likely to be near, regardless of whether the user is at home, at work, or on the move somewhere. An example of a suitable primary device is a mobile phone which is easy and customary to carry around most of the time, but the user may also assign a tablet or a laptop computer as the primary device and the solution is not limited to any particular device to be the primary device. Other devices in the user B's set of devices are then automatically defined as secondary devices simply by not being a primary device.

It is thus assumed that the user has one assigned primary device and at least one secondary device which all have been registered for the subscription. It is not necessary that he assignment of primary device is static and fixed. In some possible embodiments, two or more different devices may have been assigned to be the primary device in this context depending on the current situation of circumstances. Thus, either a first device or a second device of the set of devices may act as the primary device depending on predefined circumstances. These circumstances may relate to at least one of:
A) The time of day, week or season. For example, user B may be more likely to be near his/her PC during working hours and near his/her tablet otherwise. In that case, the PC may be assigned to act as primary device during working hours and the tablet may be assigned to act as primary device during evenings and weekends.
B) A battery status of the respective first and second devices. For example, the user B's mobile phone may be assigned to act as primary device only if its battery level is above a certain level, and if not the user B's tablet may be assigned to act as the primary device. Thereby, it may be ensured that the primary device will have enough battery level to be able to communicate and also to provide a fairly valid and updated location.
C) Connectivity of the respective first and second devices to the communication network. For example, the user B's mobile phone may be assigned to act as primary device only if it is properly connected to a radio access network with sufficient quality and/or coverage. If not, another device such as a PC with a fixed connection to the network may be assigned to act as the primary device even if it is not as likely to be near the user B.

In a further action 202, the application server also obtains a location of each of the at least one secondary device of the set of devices, which may be done before, after, or at the same time as action 200. In a possible embodiment, the application server may obtain the location of one or more of the primary and at least one secondary device in a request message, such as a registration message or other message containing location information, that is sent from the respective device. In another embodiment, the location of one or more of the primary and the at least one secondary device may be fetched from a location storage, which may be a Home Location Register, HLR, which is a device database in mobile networks, or a Home Subscriber System, HSS, which is a device database in IMS networks. Another common term sometimes used in this context is Location Base System, LBS, which denotes a database containing location information about devices, thus being a location storage. Another possibility is that the application server sends a location request to one or more of the devices to obtain the requested location therefrom.

A final shown action 204 illustrates that the application server executes the service-related operation with restriction to the primary device and to any of the at least one secondary device being located within a predetermined proximity range to the primary device. This proximity range may have been set such that if the user is near the primary device, he/she should be also within reach of a secondary device that is within the proximity range. The term “within reach” should be understood as close enough for the user to potentially notice an alert emitted from the device, such as a ring tone, and potentially use the secondary device in a communication if forthcoming. The predetermined proximity range may be configurable, e.g. depending on preferences of the user B, and a suitable proximity range could be, without limitation to this example, something like 5-15 meters.

The above term “with restriction to” should be understood in the sense that the service-related operation is executed for the primary device and for only those of the at least one secondary device, if any, that have been determined to be located within the proximity range, which can be determined from the locations obtained in actions 200 and 202. It should be noted that in this solution possibly all, or none, or any number of the user's secondary devices may happen to be within the proximity range to the primary device. Consequently, if none of them is determined to be within the proximity range, the service-related operation will be executed for the primary device only. On the other hand, and if all of them are determined to be within the proximity range, the service-related operation will be executed for the primary device and for all of the secondary devices.

As mentioned above, in one embodiment, the service-related operation may comprise exchanging device capabilities with the opposite communication entity for the primary device and for those of the at least one secondary device that are located within the proximity range to the primary device. Alternatively or additionally, in another embodiment, the service-related operation may comprise forking a communication request from the opposite communication entity to the primary device and to those of the at least one secondary device being located within the proximity range to the primary device. Further, if the network comprises an IMS core, the service operation may be executed over a Serving Call Session Control Function, S-CSCF, of the IMS core. Some examples of more detailed practical use cases will be described later below.

It can be understood that this solution is highly dependent on the location of the primary device in order to decide which secondary device(s), if any, are located within the proximity range and presumably within reach for the user. However, it may sometimes happen that the location of the primary device obtained by the application server is not correct, e.g. because it is out-of-date, or “old”, and the primary device has moved elsewhere since the time it was determined. Hence, in another possible embodiment, the obtained location of the primary device may be a “latest known” location of the primary device, such as a location obtained either from a location database or from the device itself, and the service operation could then be executed with said restriction if a pre-set validity timer of the latest known location has not expired. In that case, it can be assumed that the obtained location cannot be trusted and in another possible embodiment the service operation may then be executed for the primary device and for all of the at least one secondary device, as a fall-back, if the pre-set validity timer of the latest known location has expired.

In an example, the user B may have set his/her mobile phone, acting as primary device, into flight mode such that it has no radio contact with the network and there is no current location data available for the mobile phone although the user has not moved since it was set in flight mode. The user may also carry a tablet in a bag which is located very close, i.e. within the proximity range, to the latest known location of the mobile phone which was registered before it was set in flight mode. Provided that the pre-set validity timer of the latest known location has not expired, any capability request or communication request directed to the user B will be forked to the tablet in this case. The pre-set validity timer may also be configurable, e.g. depending on how much the primary device is moving around, and a suitable “normal” value might be in the range of 10-30 minutes.

In yet another possible embodiment, the application server may maintain the distance between each secondary device and the primary device, or at least an indication of that distance, in a device location document that may be retained at the application server or other node that can be accessed by the application server. Furthermore, if just an indication is maintained, it may be sufficient in this context that the indication simply indicates whether the respective secondary device is within the proximity range to the primary device or not, which could be represented by a single information bit or flag set to 1=within range or 0=beyond range, or vice versa.

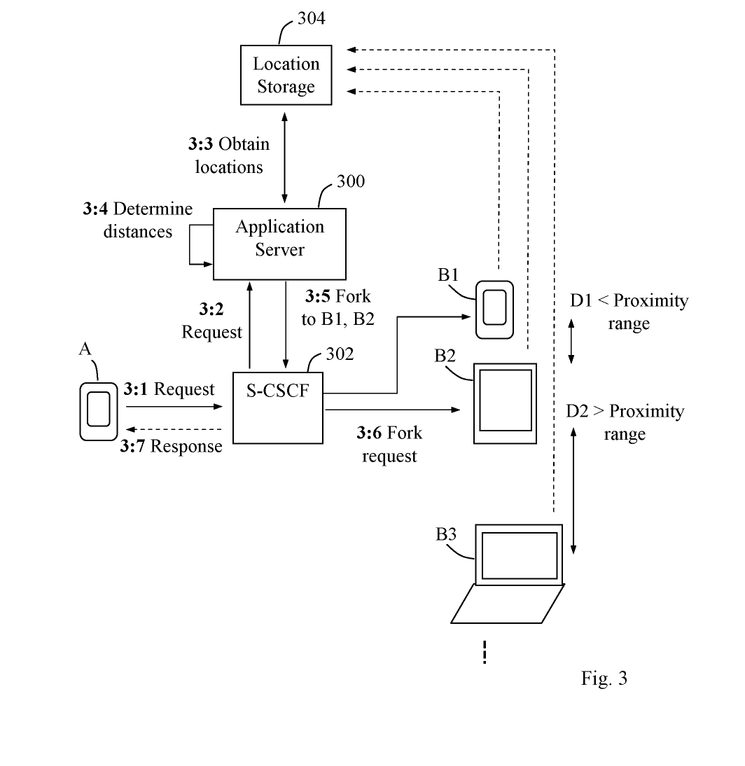

FIG. 3 illustrates how the solution of FIG. 2 may be applied in practice in the context of an IMS network, involving an application server 300 connected to an S-CSCF node 302 of an IMS core, the node 302 serving a user B who has a mobile phone B1 that has been assigned to be the primary device, and also has a tablet B2 and a PC B3, both acting as secondary devices since they have not been assigned as primary device. The user may have further devices as well, although not shown in this simplified example, and it can be understood that this procedure is essentially applicable for one primary device and any number of secondary devices. It is assumed that the user has registered his/her set of devices B1-B3 in an IMS subscription and that the locations of devices B1-B3 are available from a location storage 304. A first action 3:1 illustrates that a request sent by an opposite communication entity of a user A, is received by the S-CSCF node 302 according to regular procedures. The request may e.g. be a capability request or a communication request as explained above.

The request is forwarded from the S-CSCF node 302 to the application server 300 in a following action 3:2, likewise according to regular procedures, in order to be processed. Next, the application server 300 identifies which devices the user B has registered in the IMS subscription, i.e. devices B1-B3, and obtains a location of each of the identified devices B1-B3, in this case from the location storage 304, in an action 3:3. The dashed arrows from devices B1, B2 and B3 indicate schematically that their respective locations have been registered and stored at the location storage 304. The application server 300 is also aware that one of the user's devices has been assigned and registered to act as a primary device, in this case the mobile phone B1, which may be part of user settings or the like. The application server 300 then determines the mutual distance between each of the secondary devices B2, B3 and the primary device B1 based on the obtained locations, in another action 3:4, in order to determine which, if any, of the secondary devices B2, B3 is/are located within the above-described predefined proximity range.

In this example, the application server 300 finds that the tablet B2 is located at a distance D1 which is within the proximity range, and that the PC B3 is located at a distance D2 which is beyond the proximity range, as indicated in the figure. Consequently, the application server 300 sends an instruction or the like to the S-CSCF node 302, in an action 3:5, to fork the request to the mobile phone B1 and to the tablet B2 but not to the PC B3, thereby restricting the service-related operation to the primary device B1 and the secondary device B2 that is located within the proximity range to the primary device B1. The request is then forked accordingly, in an action 3:6, to devices B1 and B2, which may return capabilities and/or other suitable response to the S-CSCF node 302. The devices B1 and B2 may also emit an alert such as a ringing tone if the request refers to a forthcoming communication session, which presumably can be detected by the user who is free to answer the call from any of the devices B1 and B2.

Having received responses from the devices B1 and B2, e.g. containing capabilities of the respective devices, the S-CSCF node 302 may create an aggregated response with device capabilities from the responses of the respective devices B1, B2 and the aggregated response may be sent to the device of user A if required, in a final shown action 3:7. In this context, the aggregated response of action 3:7 may be created according to regular procedures which are thus somewhat outside the scope of this solution. If the request requires device capabilities, the response of 3:7 will contain capabilities of B1 and B2 and all services that are available according to the capabilities of devices B1 and B2, but not B3, will be displayed at the device of user A. In any case, no signaling will be performed to execute the service-related operation for device B3 since such signaling would be wasted anyway because the user A is not within reach of device B3 and cannot use it for communication.

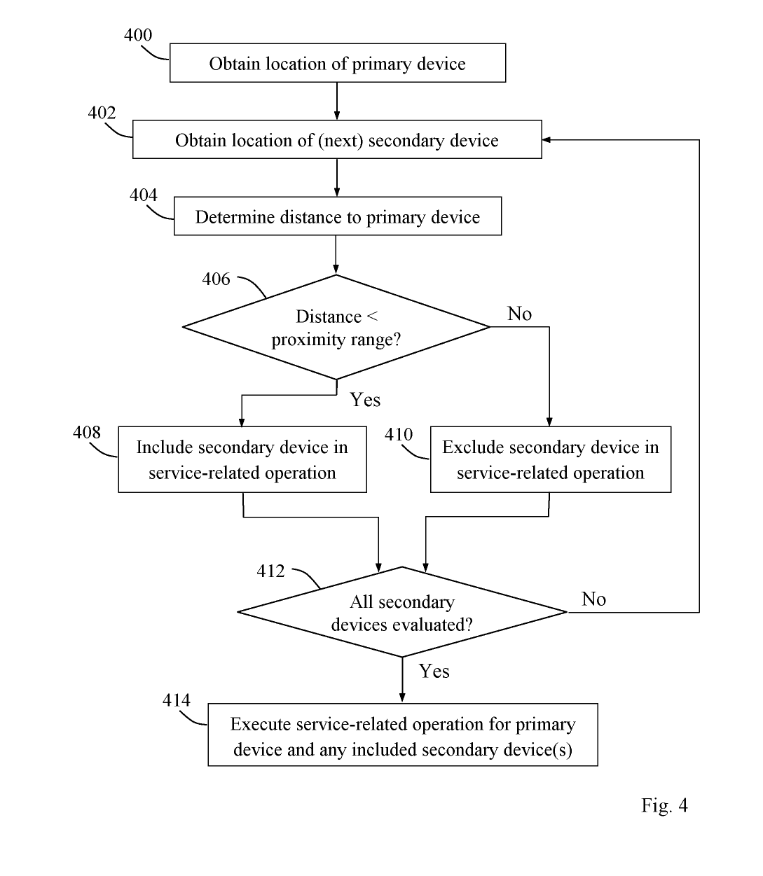

A more detailed example of how the above-described application server may operate to execute a service-related operation when the solution is employed, will now be described with reference to the flowchart of FIG. 4. Again it is assumed that the user B has a set of devices including an assigned primary device and one or more secondary devices. In a first action 400, the application server obtains a location of the primary device, which corresponds to action 200 described above. In another action 402, the application server obtains a location of one of the secondary devices to be evaluated with respect to a predefined proximity range, which basically corresponds to action 202 described above.

The application server then determines the resulting distance between the secondary device and the primary device based on the obtained locations, in another action 404. In a further action 406, the application server further determines whether the determined distance is within the proximity range. If so, the application server includes the evaluated secondary device in the service-related operation, in an action 408, but if not the application server excludes the evaluated secondary device in the service-related operation, in an alternative action 410.

Next, it is determined in an action 412 whether all the secondary devices have been evaluated or not. As long as there is another secondary device left to evaluate, the process returns to action 402 in order to repeat the evaluation of the next secondary device according to actions 402-410 in the manner described above. Once it is determined in action 412 that there are no more secondary devices to evaluate, that is all secondary devices have been evaluated, the process ends with the application server proceeding to execute the service-related operation, in action 414, for the primary device and for the secondary device(s) that was/were included, if any, in the service-related operation according to action 408.

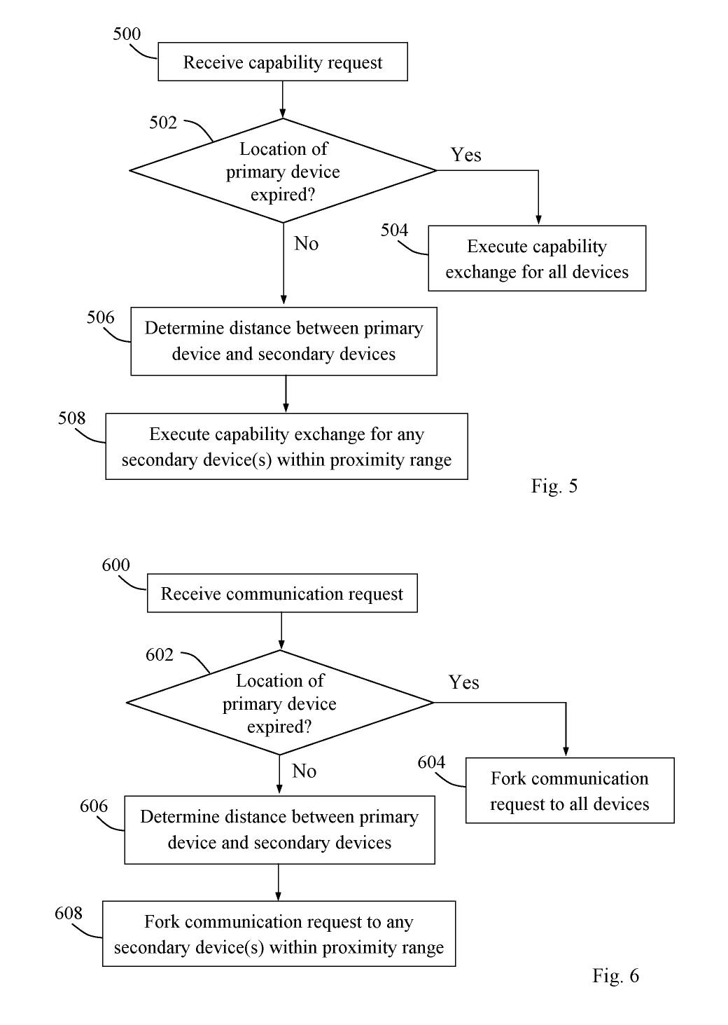

It was mentioned above that the location of the primary device obtained by the application server might be deemed unreliable because it is out-of-date, i.e. too old, after a pre-set validity timer of the latest known location has expired. Some examples of how the above-described application server may operate to execute a service-related operation when this embodiment is employed, will now be described, first with reference to the flowchart of FIG. 5 where the service-related operation involves a capability exchange between users A and B.

In a first shown action 500, the application server receives a capability request sent from a communication entity of user A and which is directed, or addressed, to user B. The application server then obtains a location of the primary device and determines in an action 502 whether its pre-set validity timer has expired or not. If it has expired, the location is deemed to be unreliable and the application server executes a capability exchange for all of the devices of the user B, i.e. as a fall-back to be on the safe side, in an action 504. In this case, no secondary devices are evaluated with respect to the predefined proximity range.

However, if the pre-set validity timer has not expired according to action 502, the application server employs the solution of evaluating the secondary devices in terms of the proximity range as described above, as indicated by action 506, and executes a capability exchange for the primary device and for any secondary device being within the proximity range, as shown in action 508. Actions 506 and 508 basically correspond to actions 202 and 204 described above.

A similar example is illustrated by the flowchart of FIG. 6 where the service-related operation in this case involves a communication request sent from user A and directed to user B. In a first action 600, the application server receives the communication request. The application server further obtains a location of the primary device and determines in an action 602 whether the pre-set validity timer of the primary device's location has expired or not. If it has expired, the location is deemed to be unreliable and the application server forks the communication request to all of the devices of the user B, as a fall-back, in an action 604.

However, if the pre-set validity timer has not expired in action 602, the application server evaluates the secondary devices in terms of the proximity range in action 606, and forks the communication request to the primary device and to any secondary device being within the proximity range, as shown in action 608. Actions 606 and 608 likewise correspond to actions 202 and 204 described above.

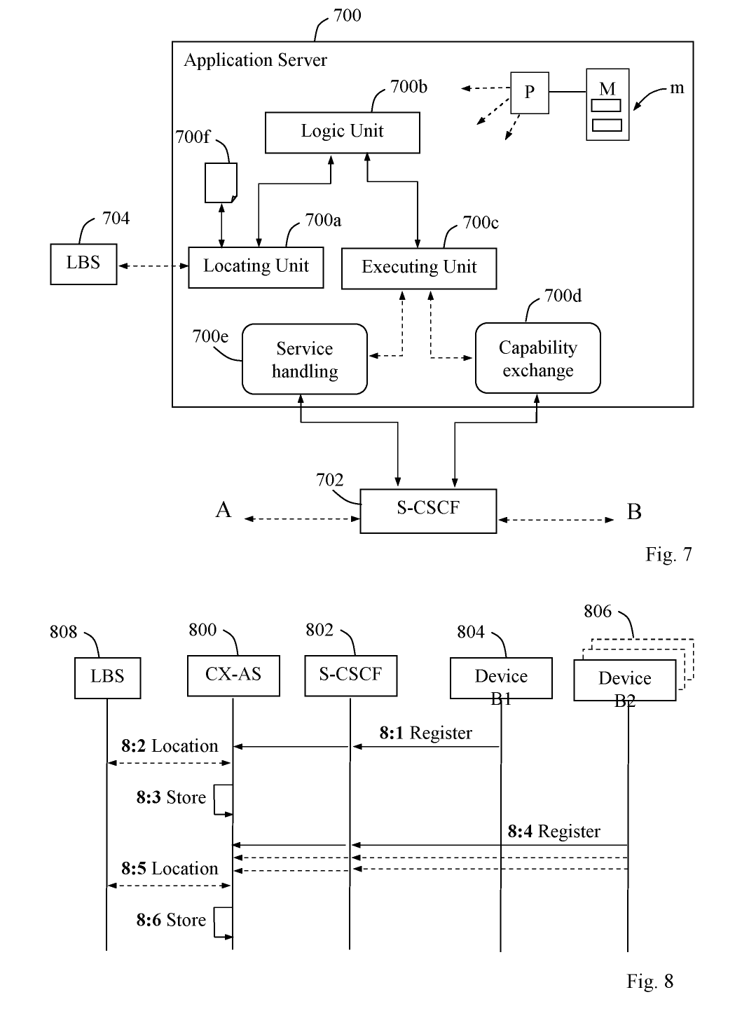

A detailed but non-limiting example of how an application server associated with a communication network, may be structured with some possible functional units to bring about the above-described operation of the application server, is illustrated by the block diagram in FIG. 7. In this figure, the application server 700 is arranged to execute a service-related operation for a device user B in communication with an opposite communication entity A, wherein the device user B has a subscription that is valid for a set of devices, not shown here. The application server 700 may be configured to operate according to any of the examples and embodiments of employing the solution as described above and as follows.

The application server 700 comprises a locating unit 700a that is adapted to obtain a location of a primary device of the set of devices, such as device B1 in FIG. 3, and basically as described e.g. for actions 200 and 400 above. It is assumed that the primary device has been assigned to indicate the device user's location. The locating unit 700a is also adapted to obtain a location of each of the at least one secondary device, such as devices B2 and B3 in FIG. 3, basically as described e.g. for actions 202 and 402 above. The locations of the primary and secondary devices may be obtained from a location storage 704 or from the devices themselves by sending a location request to them.

The application server 700 further comprises a logic unit 700b that is adapted to determine whether at least one secondary device of the set of devices is located within a predetermined proximity range to the primary device, basically as described e.g. for actions 404 and 406 above. The application server 700 also comprises an executing unit 700c adapted to execute the service-related operation with restriction to the primary device and to any of the at least one secondary device being located within the predetermined proximity range to the primary device, basically as described e.g. for actions 204 and 408-414 above.

The above application server 700 and its functional units may be configured or arranged to operate according to various optional embodiments such as those described above illustrated by FIGS. 2-6 and further embodiments and examples to be described below with reference to FIGS. 8-12. For example, when the obtained location of the primary device is a latest known location of the primary device, the executing unit 700c may be adapted to execute the service operation with said restriction if a pre-set validity timer of the latest known location has not expired. Otherwise, once the pre-set validity timer of the latest known location has expired, the executing unit 700c may be adapted to execute the service operation for the primary device and all of the at least one secondary device, since the latest known location of the primary device is deemed to be unreliable after this time.

In another possible embodiment, the locating unit 700a may be adapted to obtain the location of one or more of the primary and at least one secondary device in a request message from the respective device, which message may e.g. comprise a communication request or a capability request, the locating unit 700a may further be adapted to fetch the location of one or more of the primary and at least one secondary device from a location storage 704, as mentioned above.

In another possible embodiment, the locating unit 700a may be adapted to maintain at least an indication of the distance between each secondary device and the primary device in a device location document 700f. In that case, the indication may indicate whether the respective secondary device is within the proximity range to the primary device or not, e.g. by means of a flag or the like being set to 0 or 1 in document 700f. The executing unit 700c may be adapted to execute the service operation over an S-CSCF node of an IMS core.

It should be noted that FIG. 7 illustrates some possible functional units in the application server 700 and the skilled person is able to implement these functional units in practice using suitable software and hardware. Thus, the solution is generally not limited to the shown structures of the application server 700, and the functional units 700a-c may be configured to operate according to any of the embodiments and features described in this disclosure, where appropriate.

The embodiments and features described herein may be implemented in a computer program comprising computer readable code which, when run on an application server, causes the application server to perform the above actions e.g. as described for any of FIGS. 2 to 6. Further, the above-described embodiments may be implemented in a computer program product comprising a computer readable medium on which a computer program is stored. The computer program product may be a compact disc or other carrier suitable for holding the computer program. The computer program comprises computer readable code which, when run on the application server 700, causes the application server 700 to perform the above-described actions. Some examples of how the computer program and computer program product can be realized in practice are outlined below.

The functional units 700a-c described above for FIG. 7 may be implemented in the application server 700 by means of program modules of a respective computer program comprising code means which, when run by a processor “P” causes the application server 700 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the application server 700 in the form of a memory “M” having a computer readable medium and being connected to the processor P. The computer program product or memory M thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the application server 700.

Some illustrative examples of how the above embodiments may be implemented in practice will now be described with reference to the signaling diagrams in FIGS. 8-12. Throughout these figures, 800 denotes an application server “CX-AS”, 802 denotes an S-CSCF node of an IMS core, 804 denotes a primary device B1 of the user B, 804 denotes one or more secondary devices B2 . . . of the user B, and 808 denotes a location storage “LBS”.

First, an example of a procedure for registration of the user's set of devices B1, B2 . . . will be briefly outlined with reference to the signaling diagram in FIG. 8.

Action 8:1—The primary device 804 registers in the IMS core by sending a message called SIP REGISTER to the S-CSCF node 802 which is forwarded to the application server 800. The message includes a device or client identity (sip. instance) although no location information is included in this message.
Action 8:2—The application server 800 obtains the location of primary device 804 from the location storage 808.
Action 8:3—The application server 800 stores the location of primary device 804, e.g. in a location document retained at the application server as described above.
Action 8:4—The secondary devices 806 likewise register in the IMS core by sending the message SIP REGISTER to the S-CSCF node 802 which is forwarded to the application server 800. No location is included in these messages either.
Action 8:5—The application server 800 obtains the location of each of the secondary devices 806 from the location storage 808.
Action 8:6—The application server 800 stores the location of the secondary devices 806.

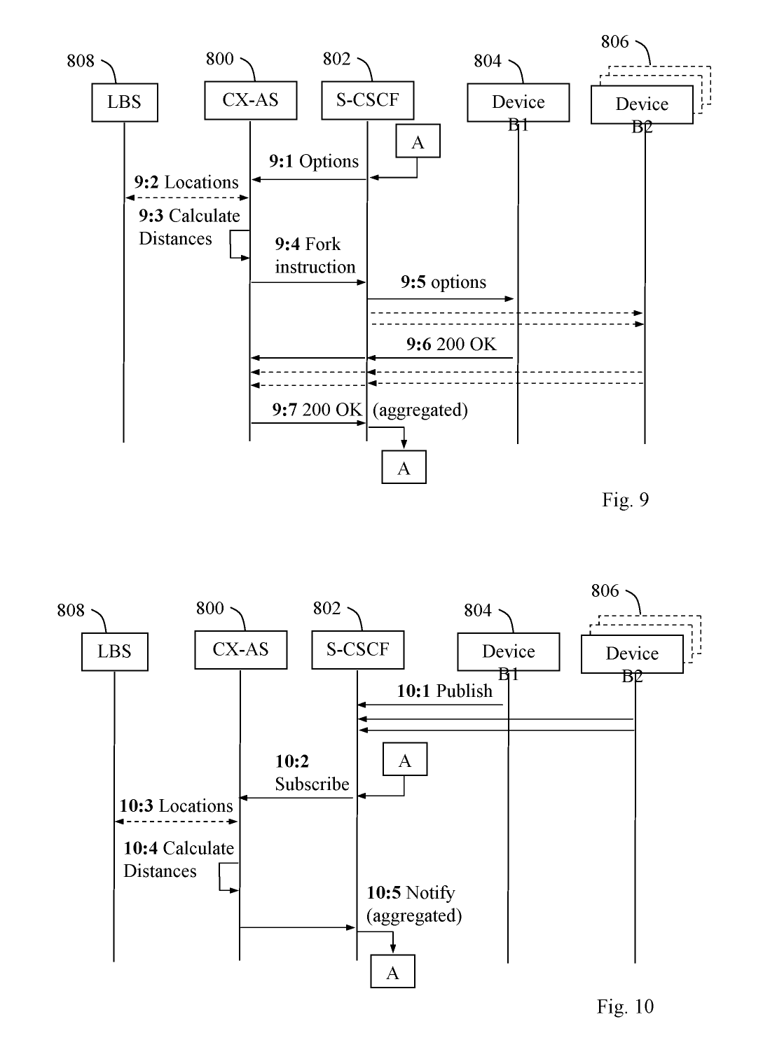

Hence, the application server 800 will have access to the respective locations of the user's devices after the above registration. In this example, no location information was included in the SIP REGISTER message from the devices which is a “normal” SIP registration. However, the device may alternatively add location information and its validity in the SIP REGISTER message if it supports the Internet Engineering Task Force, IETF, document called RFC 6442. In the following examples of FIGS. 9-12, it is assumed that the registration procedure of FIG. 8 has been performed.

Second, an example of a procedure for handling an incoming capability request using SIP OPTIONS will be outlined with reference to the signaling diagram in FIG. 9.

Action 9:1—An opposite communication entity of a user A sends a capability request in the form of a SIP request called SIP OPTIONS towards user B which is routed to the S-CSCF node 802 and then forwarded to the application server 800 for processing.
Action 9:2—If the application server 800 lacks valid location information for the devices, 804, 806, it obtains locations of the primary device 804 and each of the secondary devices 806 from the location storage 808. For example, the location saved in the registration procedure of FIG. 8 may have expired and is thus not considered to be valid anymore.
Action 9:3—The application server 800 calculates the distance between the primary device 804 and each of the secondary devices 806 based on the obtained locations, in order to determine which secondary device(s), if any, are within the proximity range to the primary device 804.
Action 9:4—The application server 800 sends a fork instruction to the S-CSCF node 802, instructing the node 802 to fork the SIP OPTIONS message to the primary device 804 and only to those secondary devices 806 that are identified as being within the proximity range, if any.
Action 9:5—The S-CSCF node 802 forks the SIP OPTIONS message accordingly.
Action 9:6—The S-CSCF node 802 receives responses from the devices 804, 806 in the form of a message called SIP 200 OK which returns capabilities of the respective devices, including those within the proximity range but not those beyond the proximity range. The S-CSCF node 802 also forwards the responses to the application server 800.
Action 9:7—The application server 800 sends an aggregated response SIP 200 OK with capabilities of the respective devices over the S-CSCF node 802 to the opposite user A.

Third, an example of a procedure for handling an incoming capability request using a presence mechanism will be outlined with reference to the signaling diagram in FIG. 10. In this example, existing presence messages can be used as follows.

Action 10:1—Each of user B's devices 804, 806 sends a message called SIP PUBLISH to the S-CSCF node 802 containing capabilities which are forwarded to and saved by the application server 800.
Action 10:2—An opposite communication entity of a user A sends a capability request in the form of a SIP request called SIP SUBSCRIBE towards user B which is routed to the S-CSCF node 802 and then forwarded to the application server 800 for processing. In this context, the application server 800 basically functions as a presence server.
Action 10:3—If the application server 800 lacks valid location information for the devices, 804, 806, it obtains locations of the primary device 804 and each of the secondary devices 806 from the location storage 808.
Action 10:4—The application server 800 calculates the distance between the primary device 804 and each of the secondary devices 806 based on the obtained locations, in order to determine which secondary device(s), if any, are within the proximity range to the primary device 804.
Action 10:5—The application server 800 triggers the S-CSCF node 802 to send an aggregated response in the form of a SIP NOTIFY message to the opposite user A. The aggregated response contains capabilities of the primary device 804 and of those secondary devices 806 that are identified as being within the proximity range, if any, but not of those being beyond the proximity range.

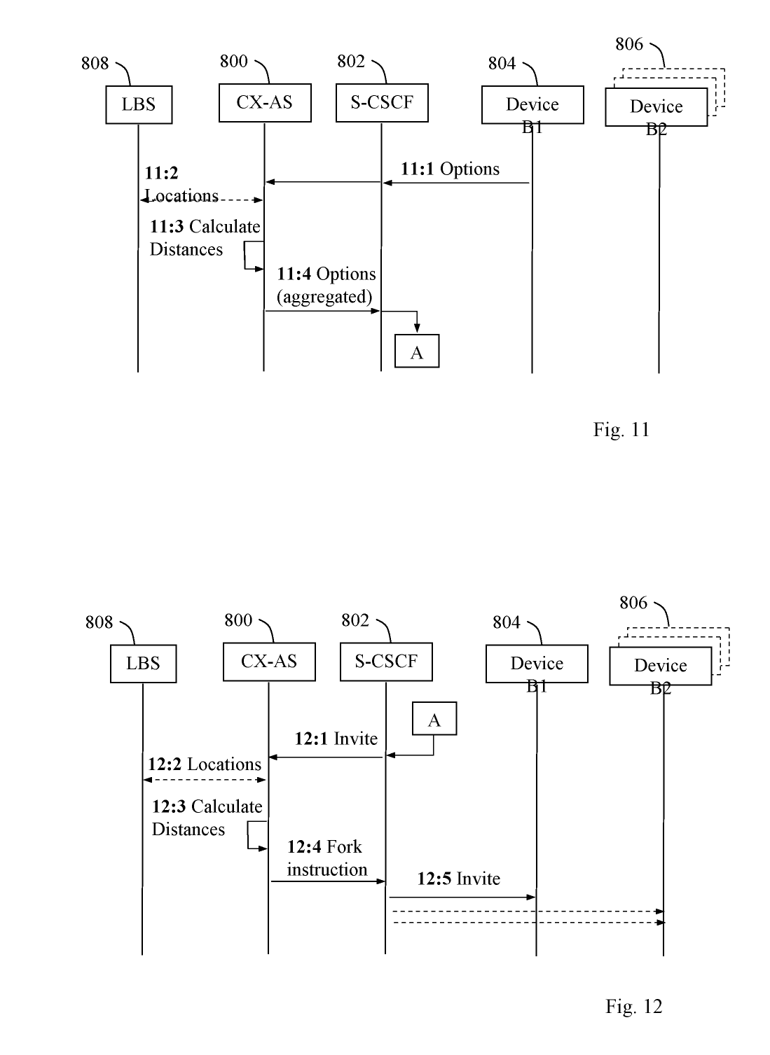

Fourth, an example of a procedure for handling an outgoing capability request using SIP OPTIONS will be outlined with reference to the signaling diagram in FIG. 11.

Action 11:1—The primary device 804 of user B sends a capability request in the form of a SIP OPTIONS message towards user A which is routed to the S-CSCF node 802 and then forwarded to the application server 800 for processing.
Action 11:2—If the application server 800 lacks valid location information for the devices, 804, 806 of user B, it obtains locations of the primary device 804 and each of the secondary devices 806 from the location storage 808.
Action 11:3—The application server 800 calculates the distance between the primary device 804 and each of the secondary devices 806 based on the obtained locations, in order to determine which secondary device(s), if any, are within the proximity range to the primary device 804.
Action 11:4—The application server 800 triggers the S-CSCF node 802 to send the SIP OPTIONS message to the opposite user A containing aggregated capabilities of the primary device 804 and of those secondary devices 806 that are identified as being within the proximity range, if any, but not of those being beyond the proximity range.

Finally, an example of a procedure for handling an incoming communication request using SIP INVITE will be outlined with reference to the signaling diagram in FIG. 12.

Action 12:1—An opposite communication entity of user A sends a communication request in the form of a SIP request called SIP INVITE towards user B which is routed to the S-CSCF node 802 and then forwarded to the application server 800 for processing.
Action 12:2—If the application server 800 lacks valid location information for the devices, 804, 806, it obtains locations of the primary device 804 and each of the secondary devices 806 from the location storage 808.
Action 12:3—The application server 800 calculates the distance between the primary device 804 and each of the secondary devices 806 based on the obtained locations, in order to determine which secondary device(s), if any, are within the proximity range to the primary device 804.
Action 12:4—The application server 800 sends a fork instruction to the S-CSCF node 802, instructing the node 802 to fork the SIP INVITE message to the primary device 804 and only to those secondary devices 806 that are identified as being within the proximity range, if any.
Action 12:5—The S-CSCF node 802 forks the SIP INVITE message accordingly to the primary device 804 and to any secondary devices 806 found to be within the proximity range.

In actions 9:1, 10:2, 11:1 and 12:1, a request is forwarded from the S-CSCF node 802 to the application server 800. This may be done in practice by provisioning the user B with an iFC that triggers the S-CSCF node 802 to forward the request to the application server 800 which will check the available location information. The iFC may be used in this context according to well-known techniques not necessary to describe here in any detail. Further, the application server 800 may create the fork instruction of actions 9:4 and 12:4 by adding a Reject-Contact header in the respective SIP request to indicate those secondary devices 806 that are identified as being beyond the proximity range, if any, which are to be excluded in the forking operation.

While the solution has been described with reference to specific exemplary embodiments, the description is generally only intended to illustrate the inventive concept and should not be taken as limiting the scope of the solution. For example, the terms “application server”, “primary device”, “secondary device” and “service-related operation” have been used throughout this description, although any other corresponding entities, functions, and/or parameters could also be used having the features and characteristics described here. The solution is defined by the appended claims.

1. A method performed by an application server associated with a communication network, for executing a service-related operation for a device user in communication with an opposite communication entity, wherein the device user has a subscription that is valid for a set of devices, the method comprising:
obtaining a location of a primary device of the set of devices, wherein the primary device has been assigned to indicate the device user's location;
obtaining a location of each of at least one secondary device of the set of devices; and
executing the service-related operation with restriction to the primary device and to any of the at least one secondary device being located within a predetermined proximity range to the primary device.

2. The method according to claim 1, wherein the service-related operation comprises exchanging device capabilities with the opposite communication entity for the primary device and for those of the at least one secondary device being located within the proximity range to the primary device.

3. The method according to claim 1, wherein the service-related operation comprises forking a communication request from the opposite communication entity to the primary device and to those of the at least one secondary device being located within the proximity range to the primary device.

4. The method according to any of claim 1, wherein the obtained location of the primary device is a latest known location of the primary device.

5. The method according to claim 4, wherein the service operation is executed with said restriction if a pre-set validity timer of the latest known location has not expired.

6. The method according to claim 5, wherein the service operation is executed for the primary device and all of the at least one secondary device if the pre-set validity timer of the latest known location has expired.

7. The method according to any of claim 1, wherein the location of one or more of the primary and at least one secondary device is obtained in a request message from the respective device.

8. The method according to claim 1, wherein the location of one or more of the primary and at least one secondary device is fetched from a location storage.

9. The method according to claim 1, wherein a first device or a second device of the set of devices acts as the primary device depending on predefined circumstances relating to at least one of: time of day, week or season, battery status of the respective first and second devices, and connectivity of the respective first and second devices to the communication network.

10. The method according to claim 1, wherein at least an indication of the distance between a respective secondary device and the primary device is maintained in a device location document.

11. The method according to claim 10, wherein the indication indicates whether the respective secondary device is within the proximity range to the primary device.

12. The method according to claim 1, wherein the service operation is executed over a Serving Call Session Control Function, S-CSCF, of an IP Multimedia Subsystem, IMS, core.

13. An application server associated with a communication network, the application server being arranged to execute a service-related operation for a device user in communication with an opposite communication entity, wherein the device user has a subscription that is valid for a set of devices, the application server comprising:
a locating unit adapted to obtain a location of a primary device of the set of devices, wherein the primary device has been assigned to indicate the device user's location, and to obtain a location of each of the at least one secondary device;
a logic unit adapted to determine whether at least one secondary device of the set of devices is located within a predetermined proximity range to the primary device; and
an executing unit adapted to execute the service-related operation with restriction to the primary device and to any of the at least one secondary device being located within the predetermined proximity range to the primary device.

14. The application server according to claim 13, wherein the service-related operation comprises exchanging device capabilities with the opposite communication entity for the primary device and for those of the at least one secondary device being located within the proximity range to the primary device.

15. The application server according to claim 13, wherein the service-related operation comprises forking a communication request from the opposite communication entity to the primary device and to those of the at least one secondary device being located within the proximity range to the primary device.

16. The application server according to claim 13, wherein the obtained location of the primary device is a latest known location of the primary device.

17. The application server according to claim 16, wherein the executing unit is adapted to execute the service operation with said restriction if a pre-set validity timer of the latest known location has not expired.

18. The application server according to claim 17, wherein the executing unit is adapted to execute the service operation for the primary device and all of the at least one secondary device if the pre-set validity timer of the latest known location has expired.

19. The application server according to claim 13, wherein the locating unit is adapted to obtain the location of one or more of the primary and at least one secondary device in a request message from the respective device.

20. The application server according to claim 13, wherein the locating unit is adapted to fetch the location of one or more of the primary and at least one secondary device from a location storage.

21. The application server according to claim 13, wherein a first device or a second device of the set of devices acts as the primary device depending on predefined circumstances relating to at least one of: time of day, week or season, battery status of the respective first and second devices, and connectivity of the respective first and second devices to the communication network.

22. The application server according to claim 13, wherein the locating unit is adapted to maintain at least an indication of the distance between each secondary device and the primary device in a device location document.

23. The application server according to claim 22, wherein the indication indicates whether the respective secondary device is within the proximity range to the primary device or not.

24. The application server according to claim 13, wherein the executing unit is adapted to execute the service operation over a Serving Call Session Control Function, S-CSCF, of an IP Multimedia Subsystem, IMS, core.

25. A computer program comprising computer readable code which, when run on an application server, causes the application server to perform the method according to claim 1.

26. The apparatus adapted to perform the method according to claim 1.
